(19) United States
(12) Patent Application Publication
(10) Pub. No.: US 2017/0268467 A1
(43) Pub. Date: Sep. 21, 2017

(54) ENGINE CONTROL VALVE IN A MOTOR VEHICLE

(71) Applicant: Valeo Systemes de Controle Moteur, Cergy Saint Christophe (FR)

(72) Inventor: Grégory Hodebourg, Sartrouville (FR)

(73) Assignee: Valeo Systemes de Controle Moteur, Cergy Saint Christophe (FR)

(21) Appl. No.: 15/505,158

(22) PCT Filed: Aug. 24, 2015
(86) PCT No.: PCT/FR2015/052258

§ 371 Date: Feb. 20, 2017

(30) Foreign Application Priority Data
Aug. 25, 2014 (FR) 1457969

(51) Int. Cl. F02M 26/70; F16K 1/226

(52) U.S. Cl. CPC F02M 26/70; F16K 1/2263

(57) ABSTRACT

The invention relates to an engine control valve (100) for a vehicle, comprising a flap (112) rotatably mounted in a valve body (126) around an axis (114) separating said flap (112) into a first part (112A) and a second part (112B), said flap (112) being able to cooperate with sealing means of the valve body (126) in a closed position to stop the flow of a fluid through said flap (112) for which the first part (112A) sealingly cooperates with a first planar surface (128) of the sealing means and the second part (112B) sealingly cooperates with a second planar surface (130) of the sealing means. According to the invention, the sealing means are resiliently deformable and the first planar surface (128) and the second planar surface (130) of the sealing means are comprised in a same plane.

The invention relates to an engine control valve, as well as an engine and a motor vehicle comprising such a valve.

Traditionally, current engines comprise a pollution reduction system by recirculating exhaust gases that is made up of a pipe making it possible to cause the exhaust gases to pass toward the intake, accompanied by a heat exchanger intended to cool the burned gases and a valve, commonly called exhaust gas recirculation (EGR) valve, the opening of which is controlled by an engine control computer in order to adjust the flow rate of burnt gases reintroduced toward the intake.

The operating principle of this type of valve is thus based on the controlled rotation of a flap, able to go from a completely open position to allow the exhaust gas fluid to pass, to a closed position to block this passage.

An engine control valve therefore has a flap, which is mounted pivoting on a rotation axis, such that said axis separates the flap into a first part and a second part. It should be specified that no physical boundary forms the border between the first and second parts of the flap, said parts being fictitiously separated by a plane passing through the rotation axis of the flap and intersecting said flap perpendicularly. When this flap is in the closed position, it comes into contact with sealing means, such as a seal, that are secured to the valve body, more particularly to the inner structure of the valve body. More specifically, the first part comes into contact with one face of the seal, while the second part of said flap bears on the opposite face of said seal.

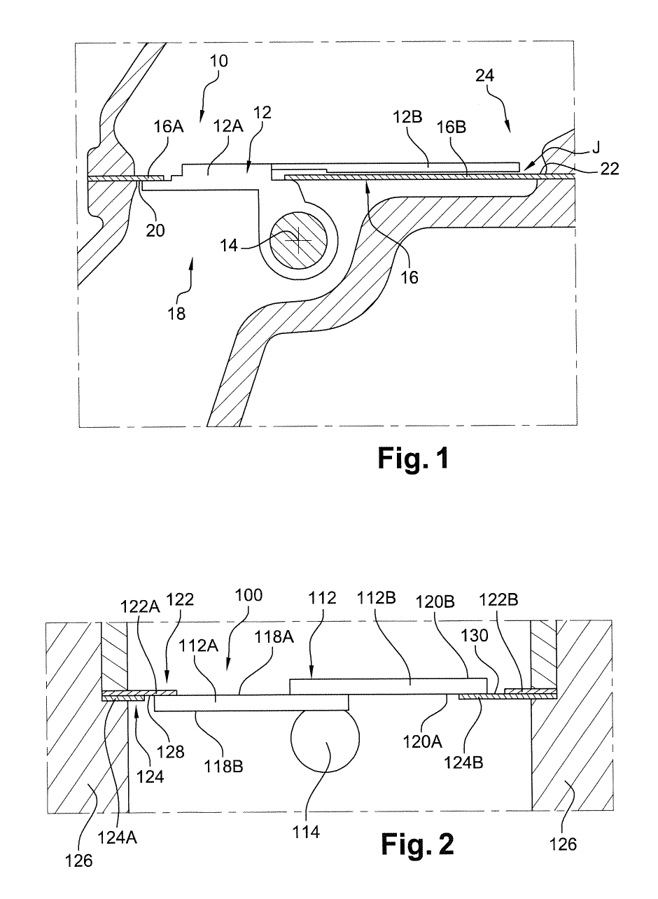

Indeed, in reference to FIG. 1, an engine control valve 10 of the prior art comprises a flap 12 mounted rotating around a rotation axis 14, separating said flap 16 into first 12A and second 12B parts, said parts 12A, 12B being connected to one another vertically and in continuation of one another. In section, the flap 12 is globally in the shape of a thin rectangular parallelepiped, the longitudinal axis of which is perpendicular to the rotation axis 14 that traverses said flap 12.

The seal 16 of the inner structure of the valve 10, against which the flap 12 bears when the latter is in a closed position, is planar and comprises a first portion 16A able to cooperate sealingly with the first part 12A of the flap 12, and a second portion 16B intended to cooperate sealingly with the second part 12 of said flap 12. The two portions 16A, 16B of the seal 16 are planar and in continuation of one another. In reference to FIG. 1, when the flap 12 pivots to close, the first part 12A rises in the direction indicated by the arrow 18, to come into sealing contact with a first planar surface 20 of the first portion 16A of the seal 16, while the second part 12B of the flap 12 is folded down on the second planar surface 22, opposite the first surface 20, of the second portion 16B of the seal 16, in the direction indicated by the arrow 24.

In practice, the bearing of the first 12A and second 12B parts of the flap 12 on the opposite faces 20, 22 on the seal 16 means that it is necessary to offset the respective bearing faces of the first 12A and second 12B parts of the flap 12. However, the machining allowances of the flap 12 and the seal 16 show that in practice, the first part 12A of the flap 12, for example, is in contact with the first portion 16A of the seal 16 and play J remains between the second portion 16B of the seal 16 and the second part 12B. This play J is thus the source of an unwanted stray gas circulation that does not allow optimal operation of the pollution reduction system.

This play J is primarily the result of the machining allowances of the flap 12 and the seal 16 as well as the positioning allowances of these elements in the valve body 10. However, reducing the machining allowances to reduce the play 1 would involve a significant increase in manufacturing costs, which is not acceptable.

Furthermore, to guarantee the proper operation of the pollution reduction system, it is important to be able to control the flow of gases through the flap 12 perfectly, and to be able to guarantee complete closing of the valve when necessary.

The invention in particular aims to improve the sealing of the valve in the closed position.

To that end, it proposes an engine control valve for a vehicle, in particular a motor vehicle, comprising a flap rotatably mounted in a valve body around an axis separating said flap into a first part and a second part, said flap being able to cooperate with sealing means of the valve body in a closed position to stop the flow of a fluid through said flap for which the first part sealingly cooperates with a first planar surface of the sealing means and the second part sealingly cooperates with a second planar surface of the sealing means, characterized in that the sealing means are resiliently deformable and in that the first planar surface and the second planar surface of the sealing means are comprised in a same plane.

According to the invention, the bearing surfaces of the first and second surfaces of the sealing means on which the first and second surfaces of the flap bear are contained in a same plane, which avoids having to offset the bearing surfaces of the first and second parts of the flap relative to one another. Furthermore, using elastically deformable sealing means makes it possible to perform a resilient deformation of the seals via the respective bearing surfaces in contact, which reduces the impact of the machining allowances and makes it possible to obtain good sealing of the engine control valve in the closed position.

In practice, the first part of the flap comprises a planar surface intended to bear on the first planar surface of the sealing means and the second part of the flap comprises a planar surface intended to bear on the second planar surface of the sealing means, the first and second planar surfaces of the sealing means and the planar surfaces of the first and second parts of the flap being comprised in a same plane in the closed position.

Thus, in the closed position, the bearing surfaces of the first and second parts of the flap and the first and second surfaces of the sealing means are situated in a same shared sealing plane.

In one practical embodiment of the invention, the sealing means comprise first and second annular seals with axes perpendicular to the axis of the flap and superimposed on one another, the first seal comprising a first portion protruding toward the inside of the valve relative to a first portion of the second seal and bearing the first planar surface, the second seal comprising a second portion protruding toward the inside of the valve relative to a second portion of the first seal and bearing the second planar surface.

Using two annular seals, one of which comprises a protruding part cooperating with the first part of the flap and the other of which comprises a protruding part cooperating with the second part of the flap, makes it possible to produce the assembly according to the invention easily.

Preferably, the sealing means are metal seals, in particular stainless steel.

The invention also relates to a motor vehicle, comprising at least one valve of the type described above.

The invention also relates to a motor vehicle, comprising an engine incorporating a valve as described above.

The invention also relates to a motor vehicle, characterized in that it is equipped with a device of the aforementioned type.

The invention will be better understood and other details, features and advantages of the invention will appear upon reading the following description done as a non-limiting example in reference to the appended drawings, in which:

FIG. 1 is a schematic sectional view in a plane perpendicular to the axis of the flap of an engine control valve according to the known technique, this figure having been discussed previously;

FIG. 2 is a schematic sectional view along a plane perpendicular to the axis of the flap of an engine control valve according to the invention.

Reference will now be made to FIG. 2, which shows an engine control valve 100 according to the invention comprising a flap 112 mounted pivoting around a rotation axis 114. The flap 112 comprises first 112A and second 112B parts connected to one another at the rotation axis 114. The first 112A and second 112B parts of the flap 112 are parallelepiped in section. The first part of the flap 112 comprises a first planar surface 118A and a second planar surface 118B that are opposite one another. Similarly, the second part 112B of the flap 112 comprises a first planar surface 120A and a second, opposite planar surface 120B. One end of the first part 112A of the flap 112 is arranged on the axis 114 such that its first surface 118A is opposite the axis 114 relative to its second surface 118B. The second part 112B of the flap 112 is applied at one end by its first planar surface 120A on the first planar surface 118A of the first part 112A of the flap 112.

The first part 112A and the second part 112B of the flap 112 have constant thicknesses in a direction parallel to the axis 114.

According to the invention, two resiliently deformable annular seals 122, 124 are superimposed on one another and are fastened at their outer periphery on the inner structure 126 of the valve body 100.

A first seal 122 comprises a first portion 122A protruding toward the inside of the valve 100 relative to a first portion 124A of the second seal 124 and is, in the closed position of the flap 112, arranged across from the first part 112A of the flap 112. This first protruding portion 122A of the first seal 122 comprises a first planar surface 128 intended to come into contact in the closed position with the first planar surface 118A of the first part 112A of the flap 112.

The second seal 124 comprises a second portion 124B protruding toward the inside of the valve 100 relative to a second portion 122B of the first seal 122 and is arranged, in the closed position of the flap 112, opposite the second part 112B of the flap 112. This second protruding portion 124B of the second seal 124 comprises a first planar surface 130 intended to come into contact in the closed position with the first planar surface 120A of the second part 112B of the flap 112.

As shown in FIG. 2, the planar surface 128 of the first protruding portion 122A of the first seal 122, the planar surface 130 of the protruding portion 12B of the second seal 12 and the first planar surfaces 118A, 120A of the first and second parts 112A, 112B of the seal 112 are situated in a same plane in the closed position, which makes it possible to reduce the impact of the machining allowances of the first and second parts of the flap 112 and the seals 122, 124 on the sealing of the valve 100 in the closed position.

In one practical embodiment of the invention, the annular seals 122, 124 are made from a metal material such as stainless steel. Each seal 122, 124 can for example have a thickness of about 3 mm.

The term “annular” used in relation with the seals 122, 124 here means that the seal has a closed contour, seen along the axis of the seal. It will be understood that any type of closed contour can be used as long as the shape is suitable for cooperating with a flap 112 in a valve according to the invention.

1. An engine control valve for a motor vehicle, comprising:
a flap rotatably mounted in a valve body around an axis separating said flap into a first part and a second part, said flap being able to cooperate with sealing means of the valve body in a closed position to stop the flow of a fluid through said flap wherein the first part sealingly cooperates with a first planar surface of the sealing means and the second part sealingly cooperates with a second planar surface of the sealing means,
wherein the sealing means are resiliently deformable and in that the first planar surface and the second planar surface of the sealing means are comprised in a same plane.

2. The valve according to claim 1, wherein the first part of the flap comprises a planar surface intended to bear on the first planar surface of the sealing means and the second part of the flap comprises a planar surface intended to bear on the second planar surface of the sealing means, the first and second planar surfaces of the sealing means and the planar surfaces of the first and second parts of the flap being comprised in a same plane in the closed position.

3. The valve according to claim 1, wherein the sealing means comprise first and second annular seals with axes perpendicular to the axis of the flap and superimposed on one another, the first seal comprising a first portion protruding toward the inside of the valve relative to a first portion of the second seal and bearing the first planar surface, the second seal comprising a second portion protruding toward the inside of the valve relative to a second portion of the first seal and bearing the second planar surface.

4. The valve according to claim 1, wherein the sealing means are stainless steel.

5. A motor vehicle, comprising at least one valve according to claim 1.

6. A motor vehicle, comprising an engine according to claim 5.
